(19) United States
(12) Patent Application Publication
(10) Pub. No.: US 2026/0356374 A1
(43) Pub. Date: Nov. 12, 2026

(54) VEHICLE SENSORS UTILIZATION TO ENABLE USER CUSTOMIZATION

(71) Applicant: GM GLOBAL TECHNOLOGY OPERATIONS LLC, Detroit, MI (US)

(72) Inventors: Siva Chinthalapudi, Novi, MI (US); Frank C. Valeri, Novi, MI (US); Alexander Lesnick, Alexandria, VA (US); Mati Goro, Sterling Heights, MI (US)

(73) Assignee: GM GLOBAL TECHNOLOGY OPERATIONS LLC, Detroit, MI (US)

(21) Appl. No.: 19/201,283

(22) Filed: May 7, 2025

(51) Int. Cl. B60W 50/00; G06F 3/01

(52) U.S. Cl. CPC B60W 50/0098; G06F 3/017; B60W 2050/0083; B60W 2420/403; B60W 2420/408; B60W 2540/043; B60W 2556/45

(57) ABSTRACT

A method for configuring a plurality of vehicle features in a vehicle including detecting, by a radio frequency receiver, a device identity in response to a radio frequency signal received from a mobile device, determining, by the processor a user location, a user direction of travel and a user characteristic in response to a sensor signal from an exterior vehicle sensor, retrieving, from a memory, a user profile indicative of a plurality of user preferences in response to the user characteristic, initiating a vehicle exterior function in response to at least one of the plurality of user preferences, the user location and the user direction of travel, and adjusting a vehicle interior feature in response to at least one of the user preferences, the user location and user direction of travel.

### BACKGROUND

The present disclosure relates generally to programming motor vehicle interior and exterior control systems. More specifically, aspects of this disclosure relate to systems, methods and devices for automated vehicle personalization by detecting a user identity, a user location and a user direction of travel to customize a plurality of vehicle features according to a predicted vehicle entry point and a plurality of user preferences.

Modern vehicles use a suite of sensors, including cameras, LiDAR, and radar, to perceive and understand their surroundings, enabling a range of advanced driver-assistance systems (ADAS) and autonomous driving capabilities. Cameras, serving as the primary visual sensor, capture detailed 2D images and are used for tasks such as object detection (vehicles, pedestrians, cyclists), lane detection, traffic sign recognition, and reading road markings. LiDAR (Light Detection and Ranging) systems emit laser pulses and measure the time for the light to return, generating precise 3D point clouds of the environment which are used for mapping, object shape and size estimation, and obstacle avoidance, particularly in varying lighting conditions. Radar (Radio Detection and Ranging) systems emit radio waves and detect the reflected signals for determining the range, velocity, and angle of objects, for use by adaptive cruise control, blind-spot monitoring, and forward collision warning systems, especially in adverse weather where optical sensors may be limited. The fusion of data from these diverse sensors provides a more comprehensive and robust understanding of the driving environment to enable increasingly automated driving functions. It is desirable to provide enhanced customization in a vehicle cabin application for drivers and passengers without requiring excessive action by the vehicle occupants. The above information disclosed in this background section is only for enhancement of understanding of the background of the invention and therefore it may contain information that does not form the prior art that is already known in this country to a person of ordinary skill in the art.

### SUMMARY

Disclosed herein are vehicle communications systems, vehicle user interface systems and related control logic for provisioning vehicle user interface systems, methods for making and methods for operating such systems, and motor vehicles equipped with user interface systems. By way of example, and not limitation, there is presented a system and method for vehicle occupant customization using vehicle sensors to detect and identify an approaching user, thereby triggering the retrieval and application of their personalized vehicle settings for determined seating locations like seating, climate, and infotainment.

In accordance with an aspect of the present disclosure, a user preference customization system in a vehicle comprising an external vehicle sensor for detecting a location, a direction of travel and a characteristic of a user, a memory configured to store a user profile indicative of the characteristic of the user, a processor configured to confirm an identity of the user in response to a comparison of the characteristic of the user and the user profile, and to generate a control signal indicative of an exterior vehicle feature user preference and an interior vehicle feature user preference in response to the comparison, the location and the direction of travel, wherein the exterior vehicle feature user preference and the interior vehicle feature user preference are stored in the memory and associated with the user profile, and a controller for controlling an exterior vehicle feature in response to the exterior vehicle feature user preference and an interior vehicle feature in response to the interior vehicle feature user preference.

In accordance with another aspect of the present disclosure, including a radio frequency receiver for receiving a radio frequency signal from a mobile device wherein the mobile device is at least one of a key fob associated with the user and a smartphone associated with the user and wherein the location, the direction of travel and the characteristic of the user are detected in response to receiving the radio frequency signal.

In accordance with another aspect of the present disclosure, wherein the external vehicle sensor is further configured to detect a gesture performed by the user and to couple a gesture data signal indicative of the gesture to the processor, wherein the processor is further operative to compare the gesture to a reference gesture stored in the memory wherein the reference gesture is associated with a vehicle action, and to couple a gesture control signal to the controller indicative of the vehicle action, and wherein the controller is further operative to perform the vehicle action in response to the gesture control signal.

In accordance with another aspect of the present disclosure, wherein the gesture is indicative of a security action and wherein the controller is configured to control a safety action in response to the security action, and wherein the safety action includes at least one of alerting a law enforcement agency, activating a vehicle alarm, activating a vehicle horn, activating a vehicle light and locking a vehicle door.

In accordance with another aspect of the present disclosure, wherein the external vehicle sensor is at least one of a camera, a LiDAR, and a radar.

In accordance with another aspect of the present disclosure, wherein the radio frequency signal includes an identification of a key fob, and wherein the identity of the user is configured in response to a key fob user identity.

In accordance with another aspect of the present disclosure, wherein the external vehicle sensor is further configured to detect at least one of a change in the direction of travel of the user and a change in location of the user, to couple a change data signal indicative at least one of the change in direction of travel and the change in location to the processor, wherein the processor is further operative to generate a feature change control signal in response to the change data signal and to couple the feature change control signal to the controller indicative of a vehicle action, and wherein the controller is further operative to alter an performance of the vehicle action in response to the feature change control signal.

In accordance with another aspect of the present disclosure, wherein the processor is further operative to predict an entry door for the user in response to the location and the direction of travel and wherein at least one of the exterior vehicle feature and the interior vehicle feature are associated with the entry door.

In accordance with another aspect of the present disclosure, wherein the exterior vehicle feature includes at least one of illuminating a vehicle light, transmitting an audible sound, disengaging a vehicle lock, and activating a standby mode of the vehicle.

In accordance with another aspect of the present disclosure, a method for configuring a plurality of vehicle features in a vehicle including determining, by a processor, a user location, a user direction of travel and a user characteristic in response to a sensor signal from an exterior vehicle sensor, retrieving, from a memory, a user profile indicative of a plurality of user preferences in response to the user characteristic, initiating a vehicle exterior feature in response to at least one of the plurality of user preferences, the user location and the user direction of travel, and adjusting, by a controller, a vehicle interior feature in response to at least one of the plurality of user preferences, the user location and the user direction of travel.

In accordance with another aspect of the present disclosure, including detecting, by a radio frequency receiver, a device identity in response to a radio frequency signal received from a mobile device, wherein the mobile device is at least one of a key fob and a smartphone.

In accordance with another aspect of the present disclosure, wherein the exterior vehicle sensor is further configured to detect a gesture performed by a user and to couple a gesture data signal indicative of the gesture to the processor, wherein the processor is further operative to compare the gesture to a reference gesture stored in the memory wherein the reference gesture is associated with a vehicle action, and to couple a gesture control signal to the controller indicative of the vehicle action, and wherein the controller is further operative to perform the vehicle action in response to the gesture control signal.

In accordance with another aspect of the present disclosure, wherein the gesture is indicative of a security action and wherein the controller is configured to control a safety action in response to the security action, and wherein the safety action includes at least one of alerting a law enforcement agency, activating a vehicle alarm, activating a vehicle horn, activating a vehicle light, unlocking a vehicle door, and locking a vehicle door.

In accordance with another aspect of the present disclosure, wherein the exterior vehicle sensor is at least one of a camera, a LiDAR, and a radar.

In accordance with another aspect of the present disclosure, wherein the vehicle interior feature is configured in response to a seating location of the user.

In accordance with another aspect of the present disclosure, wherein the exterior vehicle sensor is further configured to detect at least one of a change in the direction of travel of a user and a change in location of the user, to couple a change data signal indicative of at least one of the change in direction of travel and the change in location to the processor, wherein the processor is further operative to generate a feature change control signal in response to the change data signal and to couple the feature change control signal to the controller indicative of a vehicle action, and wherein the controller is further operative to alter a performance of the vehicle action in response to the feature change control signal.

In accordance with another aspect of the present disclosure, further including predicting an entry door, by the processor, in response to the location and the direction of travel and wherein at least one of the vehicle exterior feature and the vehicle interior feature are associated with the entry door.

In accordance with another aspect of the present disclosure, wherein the vehicle interior feature includes at least one of illuminating a vehicle cabin light, configuring an infotainment system, activating a standby mode of the vehicle, adjusting a seat position, adjusting a steering wheel position, initiating a heating and air conditioning system, and adjusting a setting of the heating and air conditioning system.

In accordance with another aspect of the present disclosure, a system for configuring a plurality of vehicle features in response to a plurality of user preferences including a radio frequency sensor for detecting a radio frequency signal from a user device wherein the radio frequency signal is indicative of an identifier of the user device, an vehicle sensor array including a radar, a Lidar and a camera, for detecting a location of a user, a direction of travel of the user, and a user characteristic, a processor configured for confirming a user identity in response to the identifier of the user device and the user characteristic, for retrieving a user profile from a memory in response to the user identity, for generating a control signal indicative of at least one of the plurality of vehicle features and at least one of the plurality of user preferences in response to the location, the direction of travel of the user and the user profile, and a controller for controlling the at least one of the plurality of vehicle features in response to the control signal.

In accordance with another aspect of the present disclosure, wherein the vehicle sensor array is further configured to detect a gesture performed by the user and to couple a gesture data signal indicative of the gesture to the processor, wherein the processor is further operative to compare the gesture to a reference gesture stored in the memory wherein the reference gesture is associated with a vehicle action, and to couple a gesture control signal to the controller indicative of the vehicle action, and wherein the controller is further operative to perform the vehicle action in response to the gesture control signal, and wherein the gesture is indicative of a security action and wherein the controller is configured to control a safety action in response to the security action, and wherein the safety action includes at least one of alerting a law enforcement agency, activating a vehicle alarm, activating a vehicle horn, activating a vehicle light and locking a vehicle door. The exempliﬁcations set out herein illustrate preferred embodiments of the invention, and such exemplifications are not to be construed as limiting the scope of the invention in any manner.

### BRIEF DESCRIPTION OF THE DRAWINGS

The exemplary embodiments will hereinafter be described in conjunction with the following drawing figures, wherein like numerals denote like elements, and wherein:

FIG. 1 is illustrative of an operating environment for an exemplary system for utilizing vehicle sensors to enable interior and exterior vehicle features in accordance with various embodiments;

FIG. 2 shows a block diagram illustrating an exemplary system for utilizing vehicle sensors to enable interior and exterior vehicle features in accordance with various embodiments; and

FIG. 3 shows a flow chart illustrating an exemplary implementation of a method for controlling an exemplary system for utilizing vehicle sensors to enable interior and exterior vehicle features in accordance with various embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Modern vehicles offer extensive customization of cabin features to enhance driver comfort and convenience, typically managed through a driver profile system. Drivers can manually customize vehicle cabin features through dedicated physical controls (buttons, switches, knobs) located on the dashboard, doors, or steering wheel, and increasingly via on-screen menus accessed through the vehicle's central infotainment touchscreen display to generate a driver profile. This driver profile stores settings for numerous cabin elements, such as, power seats and side mirrors which automatically adjust to the driver's pre-set positions at a push of a button. The steering wheel tilt and telescope may also move into a preferred configuration. Climate control settings, including temperature, fan speed, and air distribution, are restored. Furthermore, infotainment system preferences such as radio presets, navigation home addresses, display layouts, and even ambient lighting colors can be loaded. This customization process enables the vehicle's interior to be configured optimally for the recognized driver before or immediately upon entry.

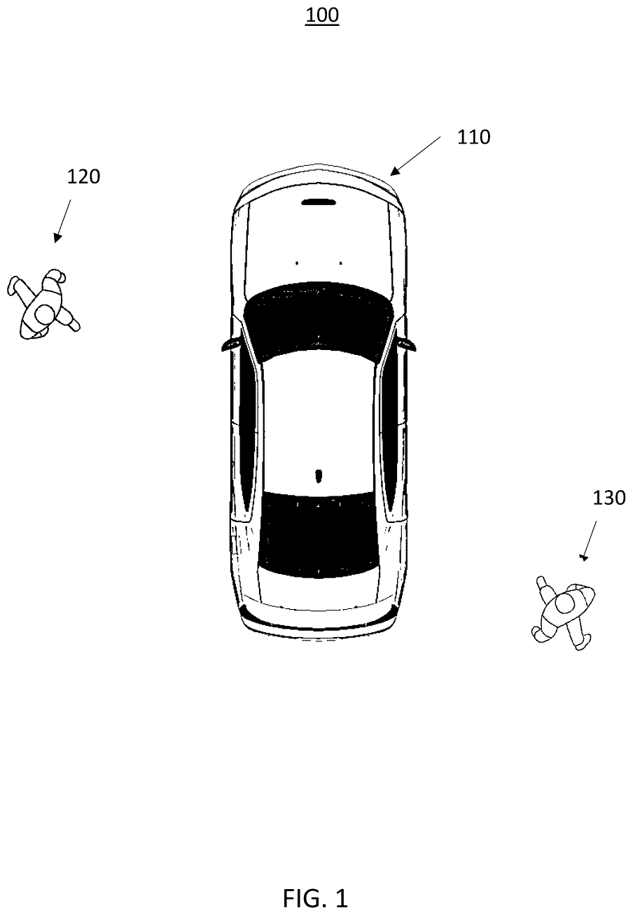

FIG. 1 shows an operating environment 100 for an exemplary system for utilizing vehicle sensors to enable interior and exterior vehicle features according to an exemplary embodiment. The exemplary environment 100 shows a vehicle 110, having a plurality of sensors typically associated with an advanced driver assistance system (ADAS). The system is configured to perform an exemplary algorithm utilizing vehicle sensors to enable interior and exterior vehicle features, increasing vehicle customization and user experience, addressing the increasing demand for personalized interactions with next-generation vehicles. Traditional vehicle system personalization often requires manual adjustments or pre-configured profiles. It would be desirable to provide seamless and proactive customization by intelligently utilizing vehicle sensor data to anticipate user needs and preferences as they interact with the vehicle.

In some exemplary embodiments, vehicle processing systems interfaced with multimodal vehicle sensing modalities, including camera, lidar, radar, and acoustics, can be used to proactively manage vehicle occupant ingress. Upon detecting one or more individuals approaching the vehicle via these sensing modalities, the system employs sensor fusion and pattern recognition algorithms to identify a first occupant 120 and a second occupant 130 without requiring explicit action from them. In some exemplary embodiments, the system can employ this identification to direct each identified occupant 120, 130 to their designated vehicle door through dynamically adjusting, personalized feedback mechanisms. This feedback, which can include external or internal sound and/or light cues, can be customized within each occupant's profile, accessible through a paired mobile phone application or the vehicle's infotainment system, and can incorporate user-defined logos, images, audio, or spoken messages. Furthermore, the system can employ heuristics, such as a calculated time-to-door metric for each approaching occupant, to dynamically modulate the characteristics of the sound and/or light feedback, optimizing the guidance process.

For some applications, the vehicle 110 can employ the existing array of sensors within the vehicle, including those employed for Advanced Driver-Assistance Systems (ADAS) and Autonomous Vehicle (AV) functionalities, in conjunction with user-carried technology such as smartphones and key fobs. By analyzing data from these sources, the system can precisely determine the location of approaching users, their velocity, direction of approach, and even identify individual passengers. An understanding of a user's intent can then be estimated via this data acquisition. The gathered information can then be used to dynamically adjust various interior and exterior vehicle features. For example, upon detecting an approaching user, the system can proactively customize settings such as seat positioning, climate control, infotainment preferences, lighting configurations, and even exterior elements like door handle presentation or welcome lighting sequences. By recognizing individual occupants and their likely intentions based on their approach, a personalized experience can be delivered seamlessly and passively, requiring no direct interaction from the occupant.

In some exemplary embodiments, vehicle sensors are used to detect and identify one or more vehicle occupants before entering the vehicle 110 and directing the occupant to a vehicle door based on heuristics using a dynamically changing sound and/or lighting feature. In response to the identification, each of the vehicle occupants 120, 130 can have customized exterior lighting for approaching their expected door within their profile. The exterior lighting can be customized to dynamically change based on the calculated time-to-door metric while the one or more vehicle occupants approach and/or can be projected to guide the one or more vehicle occupants to their expected door (i.e. lighting projected on the ground while changing intensity and location). In addition, if the expected door changes based on the one or more vehicle occupant movement, the system and method can track the one or more vehicle occupants further to associate and change the location of personalization settings.

Likewise, the exemplary vehicle sensors in conjunction with a pre-configured profile, via either mobile phone profile or vehicle infotainment profile, can be used to detect and identify one or more vehicle occupants and identify a customizable set of gestures learned by the vehicle for various vehicle actions, including one or more abort sound and/or abort lighting feature gestures to prevent false positive or unwanted vehicle lights and sounds, and one or more abort door opening gestures to prevent false positive door openings. Likewise, the sensors and/or sensor system, can be configured to detect one or more safety gestures or safety escalation gestures from the occupant 120, 130. In response, the vehicle 110 can engage an appropriate safety system, such as sound horn, flash vehicle lights, and contacting police. The system may further contact police after a certain time, and/or send surround camera video to customized emergency contacts. The sensors can be further configured to recognize an abort safety gesture to enable the system to prevent false positive safety escalation actions. Likewise, in response to the user detection and user identification, a calculated time-to-door metric and a calculated confidence matrix can be employed to allow the vehicle 110 sufficient time to customize the interior settings of the vehicle 110, with said customizations including one or more of seat placement, HVAC setting, radio settings, interior lighting, sunroof/sunshade settings, bluetooth device connections, audio settings and smart glass tint. The system may further configured the display settings of the infotainment system based on the identification of the first occupant 120 and the second occupant 130. If the expected door changes based on user movement, the exemplary system can continue to track an occupant in order to correctly associate and change location of personalization settings. Once the occupant enters the vehicle, the system can enable the user to cancel the automatic feature enablement or manually change profiles for their given seat location at a user interface on the infotaiment system or the like.

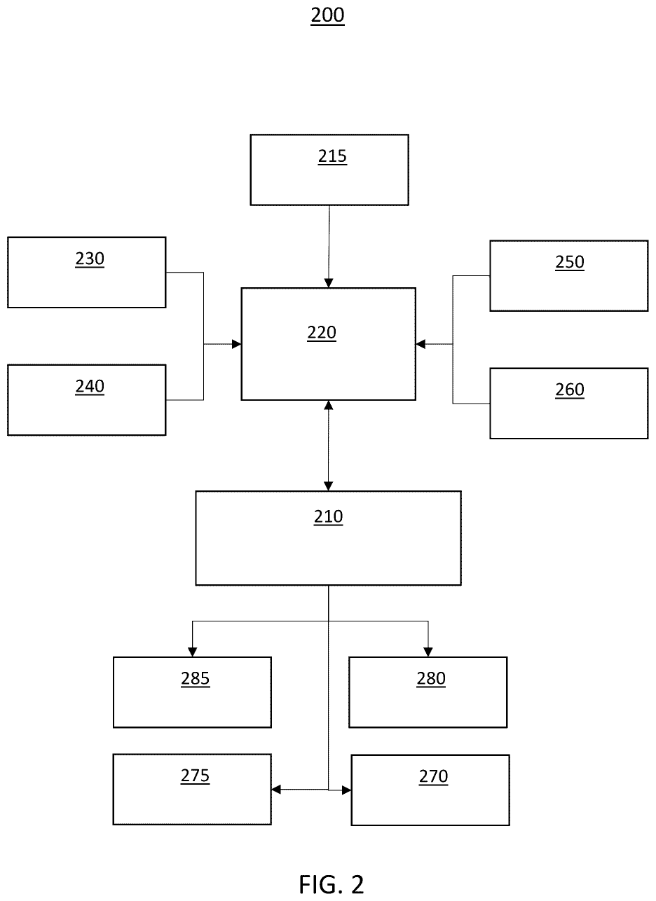

Turning now to FIG. 2, a block diagram illustrating an exemplary system 200 for utilizing vehicle sensors to enable interior and exterior vehicle features according to an exemplary embodiment. The exemplary system 200 can include an RF receiver 215, a first camera 250, a second camera 260, a radio detection and ranging (radar) sensor 230, a light detection and ranging (LiDAR) sensor 240, an electronic control unit (ECU) 220, a body control unit (BCU) 210, vehicle lighting 285, vehicle locks 280, seat positioner 275 and a vehicle cabin HVAC system 270.

Current technology being used for fob-based tracking for features like “open on approach” for power doors, lacks precise detection of the customer's location and their intent which causes customer dissatisfaction. Next generation sensor sets commonly employed by vehicle ADAS systems can be used to enable a multi-modal, precise detection methodology that will detect, classify and guide the user without needing the user to overtly or intentionally engage in a recognition process. By utilizing values such as distance, velocity, direction, camera images, sound, and 3D LiDAR data, user-identifiable characteristics based on appearance, stature, gait, and any user-customized gestures can be detected and used to perform specific functions either inside, such as seating/infotainment presets, or outside, such as pre-chosen approach music, of the vehicle.

The radio frequency (RF) receiver 215 integrated into the vehicle can be used to detect the presence of a nearby vehicle key fob by continuously monitoring a specific frequency band for signals matching the fob's unique identifier. When an approaching person carrying the fob comes within the receiver's effective range, the RF receiver 215 can detect the transmitted RF signal, which typically includes an encrypted identification code. This received code is then compared against a pre-stored database of authorized key fob identifiers. Upon successful matching, indicating the presence of a recognized owner, the system 200 interprets this detection as a trigger event. Data indicative of the detection event can then be coupled to the electronic control unit 220 which can then initiate a customization algorithm.

The radar sensor 230 can be used to detect an approaching person's location and speed by emitting radio waves and analyzing the reflected signals. To determine location (range), the radar transmits a short pulse of electromagnetic energy and precisely measures the time delay between transmission and the reception of the reflected signal (echo) from the person. Knowing the speed of light, the distance to the person can be calculated as half the total travel time multiplied by the speed of light. For speed (velocity) measurement, radar utilizes the Doppler effect. The frequency of the reflected signal will be shifted based on the relative motion between the radar and the person. If the person is moving towards the radar, the reflected frequency will be higher (blueshift), and if moving away, it will be lower (redshift). By analyzing this frequency shift, the radar can accurately determine the person's radial velocity (speed towards or away from the radar). Modern radar systems often employ sophisticated signal processing techniques to enhance accuracy and distinguish between multiple targets.

Likewise, the Light Detection and Ranging (LiDAR) sensor 240 can determine the location and speed of a nearby person by emitting short pulses of laser light and precisely measuring the reflected signals. To ascertain location (range), the system 200 measures the time-of-flight (ToF) for each emitted pulse to travel to the person and return to the LiDAR sensor 240. Knowing the speed of light, the distance is calculated as half the total travel time multiplied by the speed of light. For speed (velocity) measurement, LiDAR systems can employ two primary techniques. One method utilizes the Doppler effect, where the frequency shift of the reflected light is analyzed to determine the radial velocity of the person relative to the LiDAR sensor. This typically requires coherent LiDAR systems capable of measuring the phase of the returning light. Alternatively, by performing rapid sequential scans of the environment, the LiDAR can track the changing position of the person over time. The velocity can then be calculated by analyzing the displacement of the detected points corresponding to the person between consecutive scans, providing an estimate of their instantaneous speed and direction of motion.

Camera 1 250 and camera 2 260 can be employed to detect the location and speed of a person approaching a vehicle through the application of computer vision techniques. Initially, one or more cameras 250, 260 capture a sequence of images or video frames. Object detection algorithms, such as convolutional neural networks (CNNs), are then applied to each frame to identify and localize the person within the image, typically by generating bounding boxes or segmentation masks. To determine the person's 3D location relative to the vehicle, a monocular camera setup can utilize techniques like perspective geometry and estimation of the person's size, while a stereo camera system leverages triangulation based on the disparity between corresponding points in the left and right images. The speed of the approaching person is calculated by tracking the centroid or a key point of the detected person across consecutive frames. The displacement of this point between frames, combined with the known frame rate of the cameras 250, 260, allows for the estimation of the person's velocity vector, indicating both speed and direction of movement towards the vehicle. Advanced techniques may incorporate Kalman filters or other tracking algorithms to smooth the motion estimation and improve accuracy.

By integrating data from cameras 250, 260, LiDAR sensor 240, and radar sensor 240, the electronic control unit 220 can identify a known vehicle operator. Image processing systems can perform facial recognition by extracting features from the captured images and comparing them against a database of enrolled operators. The LiDAR sensor 240 provides detailed 3D point clouds of the approaching person, enabling the analysis of their body shape, size, and potentially gait patterns, which can serve as unique biometric identifiers. The radar sensor 230, while offering lower spatial resolution than LiDAR, can contribute by detecting the presence and velocity of the approaching individual, providing supplementary information for tracking and potentially coarse body signature analysis. Data fusion algorithms combine the outputs from these sensors, employing techniques such as sensor fusion filters or machine learning models, to correlate and weigh the evidence from each modality. For instance, a high confidence facial recognition match from the camera data could be corroborated by the expected body dimensions from the LiDAR and the appropriate approach velocity from the radar, leading to a highly reliable identification of the known vehicle operator and initiation of personalized vehicle settings.

Upon successful identification of an approaching vehicle operator, the vehicle's central electronic control unit (ECU) 220 performs the algorithm to enable the personalized customization. The verified identity is received by the ECU 220, triggering a lookup in its internal memory or a connected database to retrieve the corresponding operator profile. This profile can contain a pre-defined set of preferences for various vehicle systems. The ECU 220 then initiates a series of commands and communications across the vehicle's network (e.g., controller area network (CAN) bus) to configure these settings. For instance, the ECU 220 sends signals to adjust the power seat and mirror actuators to the operator's preferred positions, sets the climate control system to their preferred temperature and fan speed, loads their saved infotainment presets (radio stations, navigation history), and activates their customized interior and exterior lighting themes. This automated process ensures that the vehicle is tailored to the identified operator's preferences even before they enter.

The body control unit (BCU) 210 serves as a central hub for managing numerous electromechanical functions within the vehicle and directly responds to customization control signals received from the Electronic Control Unit (ECU). Upon receiving a customization signal indicating the desired state of various systems for a specific operator, the BCU 210 interprets these instructions and translates them into specific electrical commands. For vehicle locks, the BCU 210 sends signals to the door lock actuators to either engage or disengage the locking mechanisms. For vehicle lighting, the BCU 210 controls the power distribution to various interior and exterior lighting elements, adjusting brightness and activating specific patterns as dictated by the customization profile. Regarding seat position, the BCU 210 communicates with the seat motor control units, sending signals to adjust the horizontal position, vertical height, and seatback angle according to the stored preferences. Similarly, for heating, ventilation, and air conditioning (HVAC) settings, the BCU 210 controls the blower motor speed, air distribution flaps, and compressor activation based on the desired temperature and ventilation mode specified in the customization signal from the ECU 220. This communication between the ECU 220 and BCU 210, typically occurring over a vehicle network like the CAN bus, enables the seamless implementation of personalized vehicle settings.

In some exemplary embodiments, the ECU 220 can retrieves a user profile, coupling a control signal indicative of the user preferences to the BCU 210 which, in turn, begins configuring vehicle settings such as seat position, climate control preferences, infotainment presets, and potentially personalized exterior lighting sequences, preparing the vehicle for the identified occupant before they even enter. The detected proximity and velocity information can then serve as a trigger for a customization algorithm. For instance, as the system 200 detects a specific key fob approaching within a defined range and speed, the algorithm can initiate personalized settings such as unlocking the doors, adjusting seat and mirror positions, activating preferred infotainment profiles, or pre-configuring climate control based on the profile associated with that particular key fob.

In response to the gathered data, the user identification and the user preferences the internal and external vehicle features can be more adaptative and customized to create a bespoke experience. An example on the exterior is to enable a sound/lighting bespoke strategy, where the customer can have their own unique and dynamic approach sound, based on distance to arrival on the door to provide the user an intuitive and grand entry. As well as external lighting projections can direct customers to their typical door. These enhancements provide feedback to the customer to naturally guide the user toward a successful feature execution, such as a power door opening passively. The user is also able to pre-define other gestures to perform specific functions, such as (but not limited to) a safety gesture, with pre-selectable outcomes (such as any or all: calling authorities, sounding the alarm, enabling vehicle sentry mode). Other gestures include predefined cancellation or confirmation gestures giving the user an opportunity to avoid false positive or false negative feature execution. Additionally, different experiences can be customized for each user on a single vehicle based on their profiles, customized on the vehicle or the mobile app.

The exemplary system 200 enables approaching vehicle occupants to define and associate arbitrary “input gestures,” detectable by external sensors, such as camera 1 250 and camera 2 260, with a set of vehicle execution gestures corresponding to specific vehicle functions. This mapping is stored within individual occupant profiles and can be customizable, allowing for flexible configurations ranging from a single input gesture triggering a multitude of interior presets and exterior approach features to unique input gestures controlling distinct, individual functions. The system 200 is configured to process recognized input gestures according to the active occupant's defined mapping to initiate desired vehicle behaviors, such as activating personalized exterior lighting sequences, deploying automatic door unlocking mechanisms, or initiating multimedia playback. Furthermore, the system incorporates heuristics to interpret contextual cues and refine the execution of mapped functions, potentially overriding or modifying pre-programmed responses based on detected environmental or occupant states (e.g., suppressing audio playback if the occupant is carrying objects that suggest their hands are full). A defined cancel gesture or absence of a recognized gesture can also be configured to prevent or abort unintended feature activation.

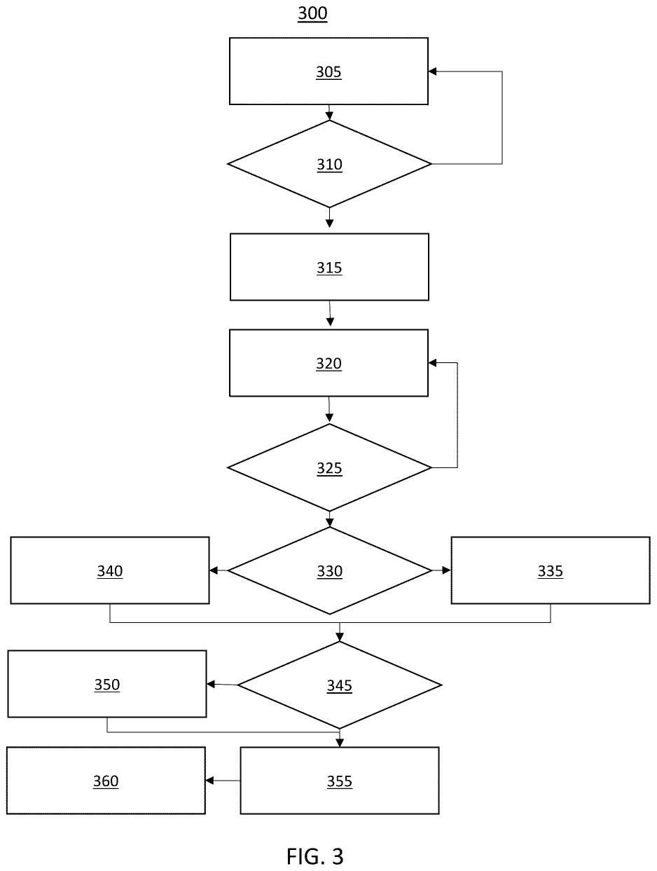

Turning now to FIG. 3, a flow chart illustrating an exemplary implementation of a method 300 for utilizing vehicle sensors to enable interior and exterior vehicle features according to an exemplary embodiment is shown. The exemplary method is 300 first operative to detect and authenticate a mobile device 305. The mobile device, such as a key fob or smartphone, when activated (either by button press or automatically upon proximity), transmits a low-power radio frequency (RF) signal containing a unique identifier and often a rolling code or cryptographic challenge response. The method 300 is configured to continuously listen for signals on the designated frequency band. Upon receiving a signal, the vehicle's body control module or a dedicated security ECU processes the incoming data. The system first verifies the unique identifier against a list of authorized mobile devices stored in the vehicle's memory. Concurrently, for enhanced security, it typically performs an authentication check using cryptographic algorithms involving the rolling code or challenge response to ensure the signal is legitimate and not a replay attack. After both the identifier is recognized and the cryptographic authentication is successful does the vehicle control system confirm the mobile device as valid, enabling subsequent actions like unlocking doors or allowing ignition. In some exemplary embodiments, the mobile device, such as a key fob, can be associated with a particular vehicle occupant.

In response to a detection and authentication of the mobile device, such as a mobile phone, the method 300 next attempts to determine 310 the identity, location, and direction of travel of a vehicle occupant by fusing data from onboard LiDAR, camera, and radar sensors. Cameras provide rich visual data enabling object detection, tracking, and potential identity determination through facial recognition or gait analysis against a database of known users. LiDAR generates a precise 3D point cloud of the environment, allowing for accurate localization and tracking of the occupant's body shape and position in three-dimensional space. Radar complements these sensors by reliably detecting the presence and velocity of the approaching occupant, particularly effective in adverse weather or lighting conditions where optical sensors may be challenged. A sensor fusion algorithm processes the data streams concurrently: tracking algorithms correlate detections across sensors and over time to establish a persistent track of the occupant's location and estimate their velocity vector, indicating their direction of travel. Simultaneously, visual features from the camera feed associated with the tracked object are fed into an identification module to match against known occupant profiles, thereby determining their identity. This fused approach leverages the strengths of each sensor modality for robust and accurate occupant sensing. If the vehicle occupant is not identified, the method 300 returns to detecting an authenticating 305 a subsequent mobile device.

In response to a successful determination 310 of an identity of the vehicle occupant, the method 300 next determines 315 a location and direction of travel of the detected vehicle occupant. This information is derived directly from the fused sensor data previously acquired from the vehicle's perception systems, including LiDAR, cameras, and radar. By processing the combined and correlated data streams from these diverse modalities, the system performs robust object tracking algorithms. These algorithms analyze the occupant's position across sequential sensor frames, establishing a precise 3D location relative to the vehicle. The change in this determined location over time is used to compute a velocity vector, the magnitude of which represents the occupant's speed and the orientation of which precisely indicates their current direction of travel towards or around the vehicle.

Based on the detected location and projected direction of travel of an approaching vehicle user, the method 300 next selectively identifies and initiates specific exterior and interior cabin features. Knowing the user's position and trajectory allows the system to anticipate their intended entry point, such as the driver's door or passenger door. Consequently, exterior features directly associated with that anticipated entry point are targeted for activation, including specific door unlocking mechanisms, deployment of associated power door handles or side mirrors, activation of puddle lights on the approach side, and the initiation of personalized exterior lighting sequences designed to guide the user to the correct door. Internally, while full activation typically awaits entry, the system can initiate preliminary adjustments of cabin features linked to the predicted entry side, such as moving the corresponding front seat towards an entry position, preparing the driver's or passenger's side climate control zones, and loading the appropriate user profile on the infotainment system in anticipation of their entry.

The method 300 is next operative to monitor the suite of vehicle-mounted sensors to capture visual data of the approaching user hand gestures 325. Advanced signal processing algorithms analyze the temporal and spatial patterns within the sensor data streams. For instance, changes in capacitance over time, coupled with specific velocity profiles from the proximity sensors and characteristic motion patterns recognized in the optical data through computer vision techniques (e.g., convolutional neural networks), are cross-correlated to identify pre-defined gestures like a wave, a tap, or a swipe. Kalman filtering or similar state estimation techniques can be employed to fuse the noisy and potentially asynchronous sensor readings, providing a robust and reliable interpretation of the occupant's intended interaction.

The method 300 next determines if the gesture is a safety gesture 330. Safety gestures can be associated with pre-selectable actions such as emergency contact initiation, audible alarm activation, and/or vehicle sentry mode engagement. If the gesture is not a safety gesture 330, the method 300 performs the action associated with the gesture 335, such as lowering the window, unlocking the door and/or opening the door. If the gesture is a safety gesture 330, the method 300 performs the safety response 340, such as locking the doors, activating the alarm or horn, calling the police and/or initiating a timer after which the police are notified. To mitigate erroneous feature execution, the system incorporates predefined cancellation and confirmation gestures, providing a mechanism for users to override or validate detected interactions. In some exemplary embodiments, the method 300 can generate use gestures in response to personalized user experiences through profile-based customization, accessible via the vehicle's interface or a dedicated mobile application, enabling tailored gesture mappings and associated function triggers for individual drivers.

In response to performing the gesture response 335 or the safety response 340, the method 300 next monitors for a change in direction 345 of the approaching occupant. If a change in direction is detected, the method changes characteristics of the feature, such as light direction, sound direction or amplitude, or the like. If no change in direction has been detected 345, or if the feature characteristic has been changed 350 in response to a direction change, the method 300 next authenticates 355 the user when the user arrives at the final destination, such as a vehicle door or the like. The method 300 then tracks 360 the user as the user enters the vehicle. The method loads the user's profile settings for the vehicle interior, such as auto phone pairing, audio levels, seat and steering wheel position, heating, ventilation and air conditioning (HVAC) settings, display preferences, etc.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A user preference customization system in a vehicle comprising:
an external vehicle sensor for detecting a location, a direction of travel and a characteristic of a user;
a memory configured to store a user profile indicative of the characteristic of the user;
a processor configured to confirm an identity of the user in response to a comparison of the characteristic of the user and the user profile, and to generate a control signal indicative of an exterior vehicle feature user preference and an interior vehicle feature user preference in response to the comparison, the location and the direction of travel, wherein the exterior vehicle feature user preference and the interior vehicle feature user preference are stored in the memory and associated with the user profile; and
a controller for controlling an exterior vehicle feature in response to the exterior vehicle feature user preference and an interior vehicle feature in response to the interior vehicle feature user preference.

2. The user preference customization system of claim 1 including a radio frequency receiver for receiving a radio frequency signal from a mobile device wherein the mobile device is at least one of a key fob associated with the user and a smartphone associated with the user and wherein the location, the direction of travel and the characteristic of the user are detected in response to receiving the radio frequency signal.

3. The user preference customization system of claim 1, wherein the external vehicle sensor is further configured to detect a gesture performed by the user and to couple a gesture data signal indicative of the gesture to the processor, wherein the processor is further operative to compare the gesture to a reference gesture stored in the memory wherein the reference gesture is associated with a vehicle action, and to couple a gesture control signal to the controller indicative of the vehicle action, and wherein the controller is further operative to perform the vehicle action in response to the gesture control signal.

4. The user preference customization system of claim 3, wherein the gesture is indicative of a security action and wherein the controller is configured to control a safety action in response to the security action, and wherein the safety action includes at least one of alerting a law enforcement agency, activating a vehicle alarm, activating a vehicle horn, activating a vehicle light and locking a vehicle door.

5. The user preference customization system of claim 1, wherein the external vehicle sensor is at least one of a camera, a LiDAR, and a radar.

6. The user preference customization system of claim 1, wherein the radio frequency signal includes an identification of a key fob, and wherein the identity of the user is configured in response to a key fob user identity.

7. The user preference customization system of claim 1, wherein the external vehicle sensor is further configured to detect at least one of a change in the direction of travel of the user and a change in location of the user, to couple a change data signal indicative at least one of the change in direction of travel and the change in location to the processor, wherein the processor is further operative to generate a feature change control signal in response to the change data signal and to couple the feature change control signal to the controller indicative of a vehicle action, and wherein the controller is further operative to alter an performance of the vehicle action in response to the feature change control signal.

8. The user preference customization system of claim 1, wherein the processor is further operative to predict an entry door for the user in response to the location and the direction of travel and wherein at least one of the exterior vehicle feature and the interior vehicle feature are associated with the entry door.

9. The user preference customization system of claim 1, wherein the exterior vehicle feature includes at least one of illuminating a vehicle light, transmitting an audible sound, disengaging a vehicle lock, and activating a standby mode of the vehicle.

10. A method for configuring a plurality of vehicle features in a vehicle comprising:
determining, by a processor, a user location, a user direction of travel and a user characteristic in response to a sensor signal from an exterior vehicle sensor;
retrieving, from a memory, a user profile indicative of a plurality of user preferences in response to the user characteristic;
initiating a vehicle exterior feature in response to at least one of the plurality of user preferences, the user location and the user direction of travel; and
adjusting, by a controller, a vehicle interior feature in response to at least one of the plurality of user preferences, the user location and the user direction of travel.

11. The method for configuring a plurality of vehicle features in the vehicle of claim 10, including detecting, by a radio frequency receiver, a device identity in response to a radio frequency signal received from a mobile device, wherein the mobile device is at least one of a key fob and a smartphone.

12. The method for configuring a plurality of vehicle features in the vehicle of claim 10, wherein the exterior vehicle sensor is further configured to detect a gesture performed by a user and to couple a gesture data signal indicative of the gesture to the processor, wherein the processor is further operative to compare the gesture to a reference gesture stored in the memory wherein the reference gesture is associated with a vehicle action, and to couple a gesture control signal to the controller indicative of the vehicle action, and wherein the controller is further operative to perform the vehicle action in response to the gesture control signal.

13. The method for configuring a plurality of vehicle features in the vehicle of claim 12, wherein the gesture is indicative of a security action and wherein the controller is configured to control a safety action in response to the security action, and wherein the safety action includes at least one of alerting a law enforcement agency, activating a vehicle alarm, activating a vehicle horn, activating a vehicle light, unlocking a vehicle door, and locking a vehicle door.

14. The method for configuring a plurality of vehicle features in the vehicle of claim 10, wherein the exterior vehicle sensor is at least one of a camera, a LiDAR, and a radar.

15. The method for configuring a plurality of vehicle features in the vehicle of claim 10 wherein the vehicle interior feature is configured in response to a seating location of the user.

16. The method for configuring a plurality of vehicle features in the vehicle of claim 10, wherein the exterior vehicle sensor is further configured to detect at least one of a change in the direction of travel of a user and a change in location of the user, to couple a change data signal indicative of at least one of the change in direction of travel and the change in location to the processor, wherein the processor is further operative to generate a feature change control signal in response to the change data signal and to couple the feature change control signal to the controller indicative of a vehicle action, and wherein the controller is further operative to alter a performance of the vehicle action in response to the feature change control signal.

17. The method for configuring a plurality of vehicle features in the vehicle of claim 10, further including predicting an entry door, by the processor, in response to the location and the direction of travel and wherein at least one of the vehicle exterior feature and the vehicle interior feature are associated with the entry door.

18. The method for configuring a plurality of vehicle features in the vehicle of claim 10, wherein the vehicle interior feature includes at least one of illuminating a vehicle cabin light, configuring an infotainment system, activating a standby mode of the vehicle, adjusting a seat position, adjusting a steering wheel position, initiating a heating and air conditioning system, and adjusting a setting of the heating and air conditioning system.

19. An system for configuring a plurality of vehicle features in response to a plurality of user preferences comprising:
a radio frequency sensor for detecting a radio frequency signal from a user device wherein the radio frequency signal is indicative of an identifier of the user device;
an vehicle sensor array including a radar, a Lidar and a camera, for detecting a location of a user, a direction of travel of the user, and a user characteristic;
a processor configured for confirming a user identity in response to the identifier of the user device and the user characteristic, for retrieving a user profile from a memory in response to the user identity, for generating a control signal indicative of at least one of the plurality of vehicle features and at least one of the plurality of user preferences in response to the location, the direction of travel of the user and the user profile; and
a controller for controlling the at least one of the plurality of vehicle features in response to the control signal.

20. The system for configuring the plurality of vehicle features in response to the plurality of user preferences of claim 19, wherein the vehicle sensor array is further configured to detect a gesture performed by the user and to couple a gesture data signal indicative of the gesture to the processor, wherein the processor is further operative to compare the gesture to a reference gesture stored in the memory wherein the reference gesture is associated with a vehicle action, and to couple a gesture control signal to the controller indicative of the vehicle action, and wherein the controller is further operative to perform the vehicle action in response to the gesture control signal, and wherein the gesture is indicative of a security action and wherein the controller is configured to control a safety action in response to the security action, and wherein the safety action includes at least one of alerting a law enforcement agency, activating a vehicle alarm, activating a vehicle horn, activating a vehicle light and locking a vehicle door.
